(19) United States
(12) Patent Application Publication
(10) Pub. No.: US 2009/0037521 A1
(43) Pub. Date: Feb. 5, 2009

(54) System and method for identifying compatibility between users from identifying information on web pages

(75) Inventors: Ran Zilca, Briarcliff Manor, NY (US); Ryan L. Osborn, Hoboken, NJ (US); Anthony Passera, South Nyack, NY (US); David Rosenbloom, Nyack, NY (US)

Correspondence Address: KEUSEY, TUTUNJIAN & BITETTO, P.C., 20 CROSSWAYS PARK NORTH, SUITE 210, WOODBURY, NY, 11797, US

(73) Assignee: SIGNAL MATCH INC.

(21) Appl. No.: 11/888,974

(22) Filed: Aug. 3, 2007

(51) Int. Cl. G06F 15/16; G06F 17/30; G06F 7/10

(52) U.S. Cl. 709/203; 707/2; 707/E17.001; 707/E17.008; 715/234

(57) ABSTRACT

A system and method for discovering and displaying the compatibility between users of a search service is presented. The searching user registers with the search service and installs a web browser toolbar or component. The searching user browses web pages, and the toolbar searches each web page for identifying information. The toolbar then transmits the identifying information to a search server, which compares the identifying information with listed identifying information for other registered users. Upon finding one or more registered users corresponding to the identifying information, the search server then determines the compatibility between the searching user and each identified registered user, sending the compatibility reports back to the toolbar. The toolbar displays the compatibility reports to the searching user in the browser.

### BACKGROUND

1. Technical Field

The present principles relate to a system and method for identifying the compatibility of users from identifying information gathered from web pages.

2. Description of the Related Art

In recent years, billions of people have used the Internet to communicate with others throughout the world. More frequently, Internet users are using the Internet to find and communicate with other users that have similar interests. For example, dating and other relationship websites permit users to publish information about themselves for other users to view, in the hopes that other compatible users will seek to contact them. In other examples, job websites have allowed employers to connect with job seekers throughout the world, or music recommendation sites may use the profiles of members to generate recommendations.

Internet users also expect a high degree of personalization to their Internet experience. While many search services have attempted to match users and provide a personalized Internet experience, the current state of the art lacks a method and system for carrying out compatibility matching throughout the Internet without dedicated web page customization.

Currently in the art, personality tests and other questionnaires are used to generate a profile score or other profile indicator relating to a person's interests, personality, or the like. However, many matching services require that a user actively search existing profiles, or require that users visit the matching service's website to view member profiles.

### SUMMARY

Presented herein are a system and method for determining and displaying the compatibility between web page users registered with a search service.

In one useful embodiment, a method for determining and displaying the compatibility of web page users may comprise the steps of a first user loading web pages into a browser having a browser component installed, where the browser component may be configured to acquire and display compatibility reports, and the browser component detecting user identifying information for a second user in the loaded web pages. The method further comprises the method steps of determining the identity of the second user from the detected user identifying information, and calculating the compatibility between the first and second users by comparing elements of a model generated for each user, which is stored on servers of the search service. A compatibility report is then generated from the calculated compatibility, and displayed to the first user. The method may further optionally comprise the method steps of listing available user identifying information regarding the second user with the search service, and generation of the user models from collected information regarding the respective users. Determining the identity of the second user may also optionally comprise the method steps of the browser component sending the detected user identifying information to the server, where the server searches the stored user identifying formation for a match with the detected user identifying information. The web pages may be loaded from a data server separate from the search service server. In other useful embodiments, the browser component may be a visible toolbar where the compatibility report is shown in the toolbar. Additionally, the method may comprise the step of the first user logging into the toolbar to activate the toolbar.

In an alternative embodiment, a system for determining and displaying the compatibility between users may be comprised of a search server and a toolbar installed on a first user's computer. The toolbar may be communicatively connected to a data server and the search server, and configured to monitor loaded web pages for user identifying information and send the detected user identifying information to the search server. The search server may be configured to receive the detected user identifying information from the toolbar and search stored user identifying information to identify a second user. The search server may be further configured to generate a report of the compatibility between the first and second users, which the search server transmits to the toolbar for display to the first user. The search server may optionally be configured to collect information from users to generate a model of each user, elements of the model used to determine the compatibility between users. The toolbar may be installed in a web browser, or may be a browser extension. The toolbar may display the compatibility report by modifying elements of a web page. The user identifying information may optionally be a URL, or may be at least one of a hyperlink embedded in a web page, an address of an electronic resource, an email address, or a username.

In yet another useful embodiment, a method for determining and displaying the compatibility between users may comprise registering a username of a first and second user with a search service, and the first user placing a widget into a web page. The widget may be configured to collect information such as a username from the second user and send the second user's username to a search server. The widget may then receive a compatibility report from the search server, and display the compatibility report to the second user. The search server may optionally execute the steps of calculating the compatibility between the first and second users to generate the compatibility report, and send the compatibility report to the widget.

The widget may be automatically generated by the search service for the first user, based on information regarding the first user. In particularly useful embodiments, the search service may be an online dating service, an employment service, or a music recommendation service.

### BRIEF DESCRIPTION OF DRAWINGS

The disclosure will provide details in the following description of preferred embodiments with reference to the following figures wherein:

FIG. 1 is a diagram showing a network for communication between a client computer and multiple servers;

FIG. 2 is a diagram showing communication flow between a browser component, a browser and multiple servers in accordance with an embodiment of the present principles;

FIG. 3 is a block/flow diagram showing a system/method for using a browser component in accordance with an embodiment of the present principles;

FIG. 4 is a block/flow diagram showing a system/method for determining compatibility of users and displaying the associated compatibility reports in accordance with an embodiment of the present principles;

FIG. 5 is a diagram of a browser displaying a compatibility report in accordance with an embodiment of the present principles; and

FIG. 6 is a diagram of a browser having a visible toolbar displaying a compatibility report in accordance with an embodiment of the present principles.

FIG. 7 is a diagram of a browser displaying a widget used to gather visiting user identifying information in accordance with an embodiment of the present principles.

### DETAILED DESCRIPTION

An improved system and method is presented for identifying the compatibility of users from identifying information gathered from web pages. Where the phrase “compatibility” is used, any relationship between a user and any other object may be determined as well. Hereinafter, the term compatibility is used to indicate the degree of unity or commonality between a user and, for example, any other user, group of users, concept, entity, or object. Therefore, compatibility may be the commonality between a user and a object, such as a music file, book, or tool. Additionally, compatibility may also be the commonality between two users, a user and a group of users, a user and a company, or any other relationship. In particularly useful embodiments, a toolbar, or other web browser component is contemplated.

In accordance with one embodiment, the toolbar may gather information from web pages browsed by a user and communicate the gathered information to a search server which determines the compatibility of the owner of the web page and the user browsing. The search server communicates, to the browser, the information regarding the compatibility of the user and the web page owner, where the compatibility information is displayed to the browser user.

Alternatively, a widget may be embedded in a web page permitting a visiting user to enter their username to determine the visiting user's compatibility with the web page owner. The widget communicates the visiting user's identifying information to the search server, which generates a compatibility profile and communicates the compatibility profile back to the browser for display.

The embodiments described here are relevant to communications devices, computers, communications networks, web browsers, or any other system or device used for browsing informational resources such as web pages, documents, or the like.

Embodiments of the present principles can take the form of an entirely hardware embodiment, an entirely software embodiment or an embodiment including both hardware and software elements. In a preferred embodiment, the present principles are implemented in software, which includes but is not limited to firmware, resident software, microcode, etc.

Furthermore, the present principles can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The methods and systems may be implemented via components usable in a web browser. The system embodied as software may be a toolbar designed for installation in a web browser. However, the system may take on any form where software is capable of analyzing web pages or other files browsed by a user over a communications network. For example, while certain browsers permit the use of toolbars, other browsers have a framework capable of accepting extensions, add-ons, or other optional browser components. Thus, using browser extensions, add-ons, or components is the equivalent of using a toolbar. The name or nature of the various software components varies depending on the browser used, but all browsers permit interaction of third party or nonstandard software. Each of these browser software embodiments may be used interchangeably without deviating from the present principles. Alternatively, the system may be embodied as a software component or stand-alone executable program configured to analyze browser or network traffic for user identification data which may be used to identify compatibility between users. Hereinafter, where the present principles are referred to as being embodied in a toolbar or browser component, any embodiment of the present principles may be implemented without deviating from the scope of the present principles.

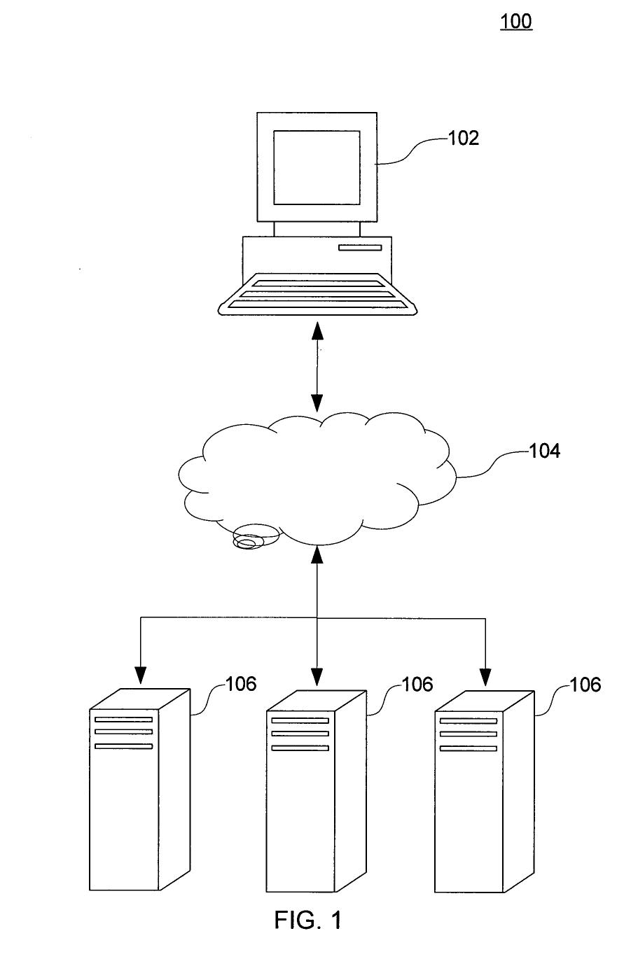

Referring now to the drawings in which like numerals represent the same or similar elements and initially to FIG. 1, a diagram shows a network 100 for communication between a client computer 102 and multiple servers 106. Particularly useful embodiments of the present principles may be deployed on such a communications network. In known configurations, a client computer 102 transmits and receives data over a communications network 104. Communications networks 104 such as the Internet, local area networks (LANs), wide area networks (WANs), intranets, wireless networks, permanent and ad-hoc networks, or the like, may advantageously permit a client to connect to a plurality of data or file servers 106. The ability of a client computer 102 to simultaneously communicate with multiple servers 106 is well known to those skilled in the art.

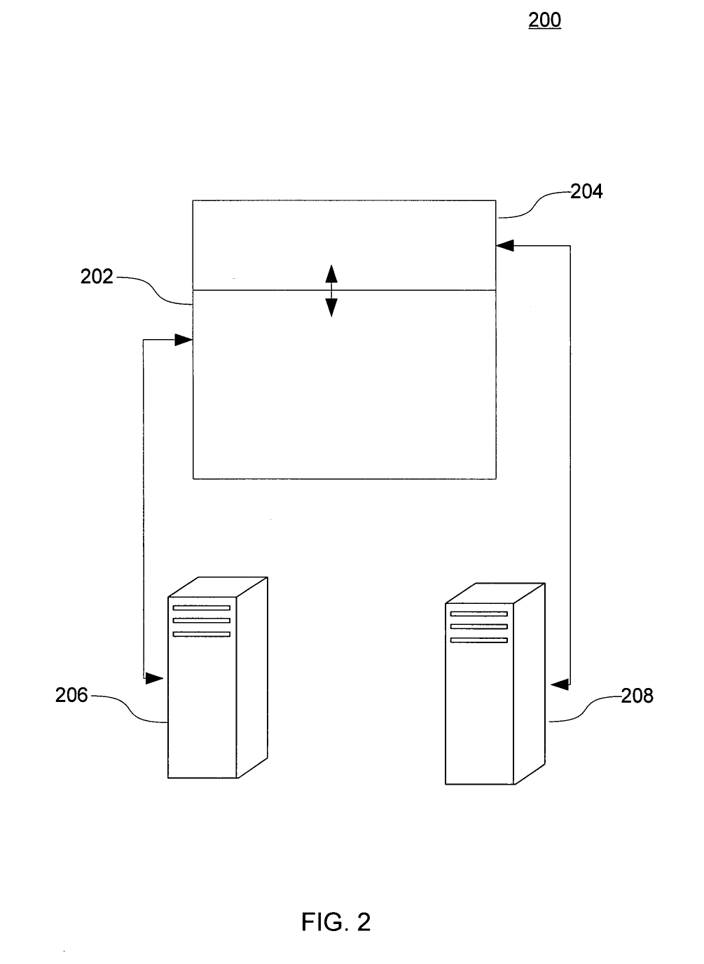

Referring to FIG. 2, a diagram is presented showing communication flow 200 between a browser component 204, a browser 202 and one or more servers, in accordance with an embodiment of the present principles. Typically, browsers 202 are in communication with at least one data server 206, permitting the browser 202 to load web pages, pictures, text documents, or other informational resources for display to a browser user. Practitioners of the digital communications arts will recognize that web browsers and other digital communications platforms may use multiple communications connections simultaneously, permitting a single browser or communication platform to send and receive data from multiple servers simultaneously.

In particularly useful embodiments, the system 200 of the present principles is a toolbar 204 or other browser extension or add-on. Such a toolbar may permit a user to passively initiate the compatibility report process. Alternatively, the system 200 of the present principles may be embodied in a widget, permitting active gathering of user information for execution of compatibility report generation.

Typically, browser components styled as toolbars are visual components that are displayed to users even when not in use. The present principles are first described in terms of a browser installed toolbar, but, according to the present principles, may advantageously be applied to browser extensions, add-on components, or other software with similar capabilities.

The system 200 of the present principles is used to gather identifying data regarding a user, and send the user identification data to the search server to generate a report of the commonality between users, such as a compatibility report. The compatibility report is generated by comparing the identified user with an already known user who is registered with the search service.

Where an embodiment is a toolbar 204 or other browser component or add-on, the browser user will install the toolbar 204, providing the toolbar 204 with a username, login i.d., or other identifying information. This identification information may be provided when the toolbar 204 is initially installed, or the toolbar 204 may permit the browser user to log in to, and out of, the toolbar. In one useful embodiment, the browser user may provide their identifying information when logging into the toolbar 204. Thus, while the toolbar 204 is active, the toolbar 204 stores the user's information identifying that particular user with the matching service. The toolbar 204 may then monitor the web pages browsed by the toolbar user. The toolbar's 204 monitoring detects information on the visited web pages that may be used to identify other users of the matching service. Upon identification of other users of the matching service, a compatibility report is generated detailing the compatibility between the browser user, and any users identified from web page information.

Alternatively, a widget may be embedded in a web page to collect identifying information regarding visiting users. Widgets are known to the art as being components executed in a browser compatible script, programming or markup language. Widgets are commonly used to embed specific functionality in a webpage without the need to rewrite large portions of code. Many websites provide application programming interfaces (APIs) for users to extend the functionality of the website to user created content. These APIs may provide prebuilt scripts, or portions of code, that may be copied into, or referenced from, a user's web page.

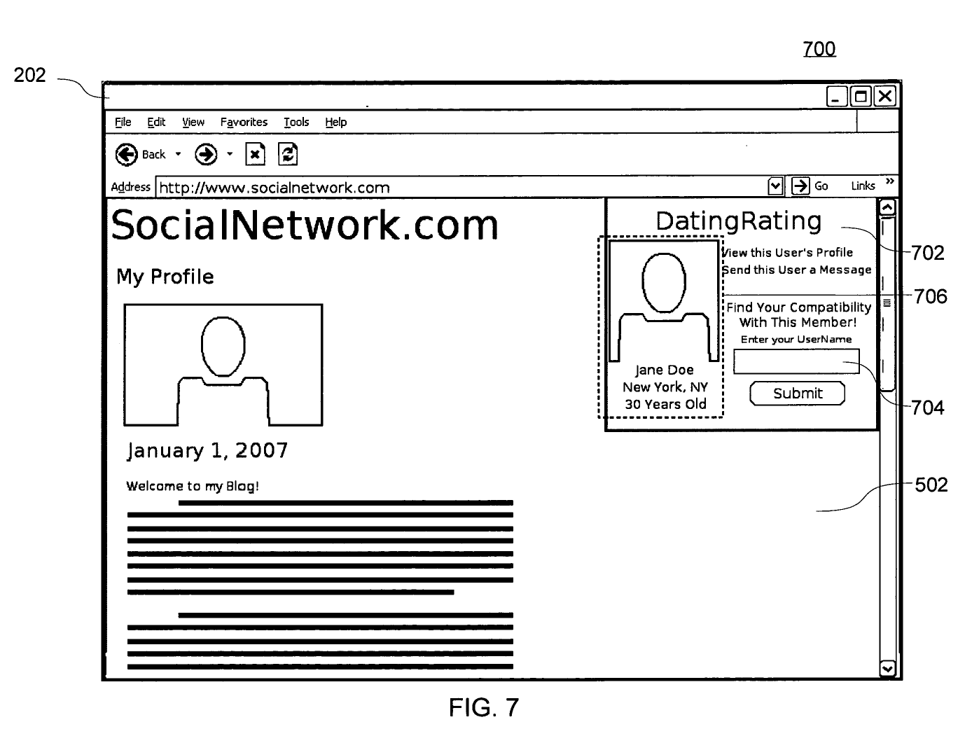

According to the present principles, a web page owner may create a web page with an embedded widget that permits a visiting user to enter their matching service username, login i.d., or other identifying information. The widget of the present principles is created with a reference to the web page owner's identifying information. When a visiting user enters information into the widget identifying themselves with the matching service, the widget may then transmit both the web page owner's and visiting user's identifying information to the search server, where a compatibility report is generated. The compatibility report may then be transmitted back to the widget and shown to the visiting user. In particularly useful embodiments, the matching service may provide an API that permits a user to enter their matching service identifying information, and uses the entered information to automatically generate a customized widget (as shown in FIG. 7) for the user to copy into their web page source code. Furthermore, the widget may be created using multiple matching service identities, or none at all. Such an API service permits a user to include the functionality of the widget without having to manually create the code calling or comprising the widget. These and other embodiments of the present principles are discussed in further detail below with respect to FIGS. 2-7.

As shown in FIG. 2, the toolbar 204 may be installed within a browser 202 such that the toolbar 204 is in bidirectional communication with the browser 202. Additionally, the toolbar 204 may be in bidirectional communication with a search server 208. In one useful embodiment, the search server 208 and the data server 206 may be different servers, and in another useful embodiment, the data server 206 and the search server 208 may be physically located in the same server. Additionally, even when located on separate physical servers, the data server 206, and search server 208 may be operated by the same search service. Such an embodiment may be particularly useful for a user searching profiles of other users registered with the same search service. Alternatively, the data server 206 may be operated by a third party, not related to the search service or the browser user.

In one useful embodiment, the toolbar 204 may scan web pages or other documents as they are loaded into the browser while the browser user navigates through various information resources. The toolbar 204 may search the web page, or any information associated with the web page, for information that may uniquely identify an owner, author, or otherwise associated user of the web page.

In yet another useful embodiment, the search server 208 may be configured to accept identification data from the toolbar 204, determine compatibility between the browser 202 user and an author, owner, or other user of a webpage displayed in the browser 202. In one embodiment, the creator of a web page may register information with the matching service that permits the matching service to link the web page creator's matching service profile with the web page. The matching service may then identify the web page creator's matching service account when identifying information from the web page is submitted to the matching service.

The search server 208 may then return the results of the compatibility matching to the toolbar 204, which may then display to the user the results of the compatibility, if any, between the browser 202 user and the web page user. In particularly useful embodiments, a compatibility report may be generated. The compatibility report may be a diadic report, that is, a report comparing two users. In another useful embodiment, the compatibility report may simply show information relating to the user being evaluated.

In particularly useful embodiments, the compatibility report may include scores based on similarity of certain traits, with scores generated for a multitude of categories. Different traits may be represented as elements of a user model. For example, where users are members of a dating service, the compatibility report may compare elements of different user's models such as, but not limited to, personality, career goals, hobbies, interests, religion, background, geographic location, communication, and the like. Alternatively, where a matching service is an employment, placement or contracting service, a compatibility report may include comparisons of management style, length of field of experience, personality, or any other factor. In such an embodiment, a company seeking to fill a job may indicate, either in the matching service profile, or in the toolbar, the traits desired in prospective employees. Thus, when a user logged into a toolbar encounters a web page identifying a member of the matching service, the toolbar may accurately generate a compatibility report using the desired characteristics compared to the characteristics of the web page user, which are stored at the matching service.

In an alternative, yet equally useful embodiment, the compatibility report may be unary, where the compatibility report compares a particular user model to the population in general. Multiple traits within the user model may be compared to corresponding general population traits, and the number of matching traits reported. Additionally, the matching rate, or the level of correlation between traits, or elements, in a user model and the general population may also be reported.

In yet another useful embodiment, the compatibility report may use elements found in a user model to generate a compatibility report. This may be particularly useful, for example, on a music recommendation site, where a user may have certain bands or composers in their model. During generation of a compatibility report, the search server may determine that users having the same bands or composers in their respective user models also have a high occurrence of an additional band listed. The compatibility report may then recommend that additional band to the user requesting the compatibility report.

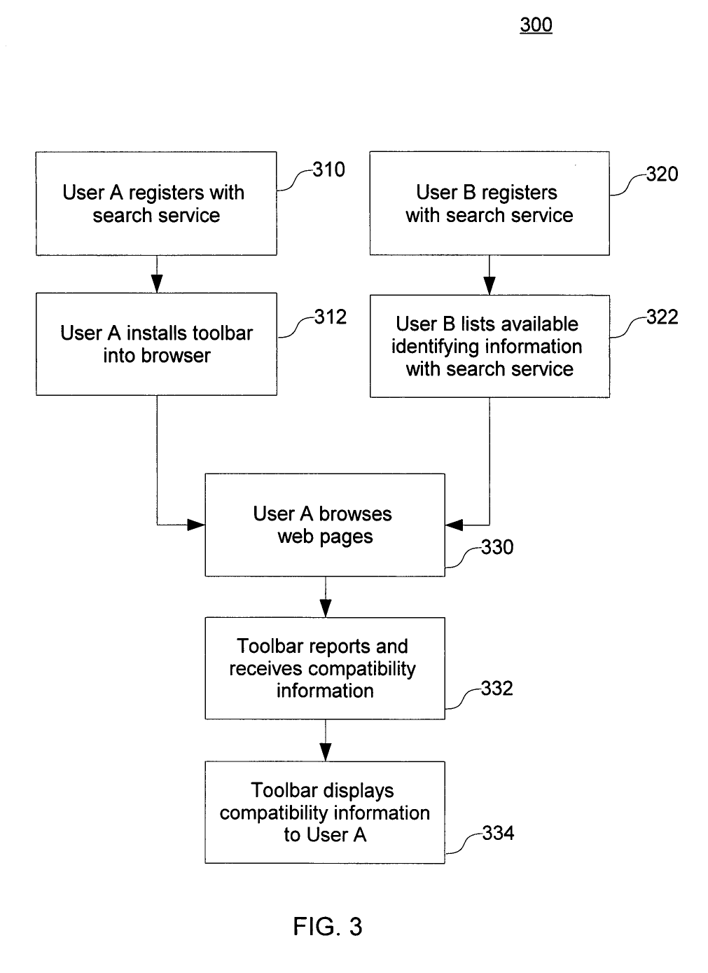

FIG. 3 depicts a block/flow diagram showing a system/method for using a browser component in accordance with an embodiment of the present principles. A search or matching service, such as an online dating or employment service may provide a service according to the present principles to users who wish to find individuals who fit into their search criteria. The use of the compatibility determination service embodying the present principles is initiated by a browser user or group (User A) registering with a relevant search service in block 310. In an embodiment where the search service is provided by, for example, an online dating service, User A may enter personal details such as age, gender, religious faith, interests and hobbies, geographic location, or any other factor that may be useful in determining compatibility between User A and other users of the online dating service. Alternatively, a user may be given a personality test, or otherwise asked questions to gauge personality traits, habits, styles or other useful personal indicators. The responses to questions or other stimuli may be used to generate a user model which may be compared to other user models or other criteria to generate a compatibility report.

For example, on a music recommendation service, a user may be given a set of stimuli, such as music clips or the like, and asked questions in response to the stimuli. The user's answers to the questions can then be used to build a model of the user's musical tastes.

Additionally, the search service may permit a family, business, or any other group of users to register as a single entity. For example, in an online employment matching service, a business may register with the employment service to actively seek qualified candidates. After registration in block 310, User A may then install the toolbar 204, FIG. 2 into a browser 202, FIG. 2 in block 312. In one useful embodiment, the toolbar 204, FIG. 2 is provided by the search service for use by registered members.

In block 320, a second user (User B) may also register with the search service, inputting any personal information that may be useful in determining the compatibility of User B with other users of the search service. The web page user (User B) may also be a group. For example, an athletic or social group may register with the compatibility matching service. In such a situation, a biker group from northern California may register with the service to attract new member. Such group registration would permit a browsing user to discover that they may not be compatible with the registered biker group.

In an alternative, yet equally useful embodiment, a user may register a single account with a search service, providing personal information for other users to search, as in block 320, and also registering to search for other users, as in block 310.

After registration in block 320, User B may then, in block 322, list available identifying information with the search service. In another useful embodiment, identifying information may be automatically entered for User B by the search server upon registration in block 320. This may be advantageous in an embodiment where the search service provides profiles or other web page services to users, and User B already has a profile viewable through the search service by web browser users. Thus, having already created a profile, the search server 208, FIG. 2 may automatically add the URL of the profile page to User B's list of user identifying information.

Referring again to block 322, when User B registers available identifying information with the search service, specific web pages may be specified, or entire websites may be registered with the search service. For example, a user may register the complete URL as user identifying information, or a single page or directory within a website. Furthermore, any registered website or web page address may include additional information, such as a query string, which would allow the search service to more accurately identify web pages or other resources which User B is associated with. In one useful embodiment, a user with a profile on a social networking site may enter the URL of the user's web page on the social networking site. For example, a user with a blog (or weblog) with its own domain name may register the domain name with the search service. In such an embodiment, the search service may advantageously recognize individual web pages of the website as belonging to the registering user, without the requirement that the user register each individual web page.

It should be noted users are not limited to registering only websites and web pages. The identifying information entered to identify User B may take virtually any form. For example, users may register the URL of any resource available on a communications network. This may include, but is not limited to, user names, email addresses, pictures and images, non-HTML informational resources such as word processing documents and spreadsheets, resumes, technical papers, bookmarks, or any other electronically deliverable information resource. Thus, in one useful embodiment, users posting information on websites and blogs commonly identify themselves using usernames, icons, or email addresses. These forums may display or provide identifying information that may be detected by the toolbar when another user browses the website.

For example, on a social networking site, a user may register the username in their list of user identifying information. Listing the username in such manner permits other users to identify the user as a search service member when the user, for example, posts a comment to a web page, but does not own the web page the comment is posted to. In such a case the toolbar may detect that a username exists on the webpage, and send the username to the search server to determine if the user is registered with the search service. Upon determining that the username is registered with the search service, the search server may identify the user associated with the received username and generate a compatibility report. Alternatively, when the user posts a comment online, the user's picture may be displayed and/or the user's email address may be provided as a link anchored to the user's user name. Registering pictures and email addresses as identifying information may also be an additional, advantageous, method for identifying search service users.

Additionally, the use of URLs, web page address, and other standard Internet identifiers permits users to create and publish content that would be identifiable to other search service users without the need to inject or add specialized text, tags, images, or the like, specifically for the search service.

Once User A has installed the toolbar 204, FIG. 2 in block 312, and User B has registered available identifying information with the search service in block 322, User A may then browse web pages normally in block 330. As User A browses the web pages, the toolbar 204, FIG. 2 may be optionally active. Such activation may be provided by a login mechanism within the toolbar 204, FIG. 2 itself, wherein User A manually logs into the search service. Alternatively, the toolbar 204, FIG. 2 may automatically log User A into the search service every time the toolbar 204, FIG. 2 is loaded by the browser. In particularly useful embodiments, the toolbar 204, FIG. 2 gives the user the option of logging out, subsequently disabling the functionality of the toolbar 204, FIG. 2. Additionally, other useful embodiments may permit different users to log into the toolbar 204, FIG. 2 independently, so that multiple users may make use of the toolbar 204, FIG. 2 without interfering with each other.

While User A browses web pages in block 330, the toolbar 204, FIG. 2, when active, analyzes the web pages to detect user identifying information of other users, groups, or items registered with the search service. The toolbar 204, FIG. 2, upon finding anything that could be identifying information, reports the user identifying information, in block 332, to the search server 208, FIG. 2. The toolbar 204, FIG. 2 also, in block 332, receives the compatibility report from the search server 208, FIG. 2, and displays the compatibility report to User A in block 334.

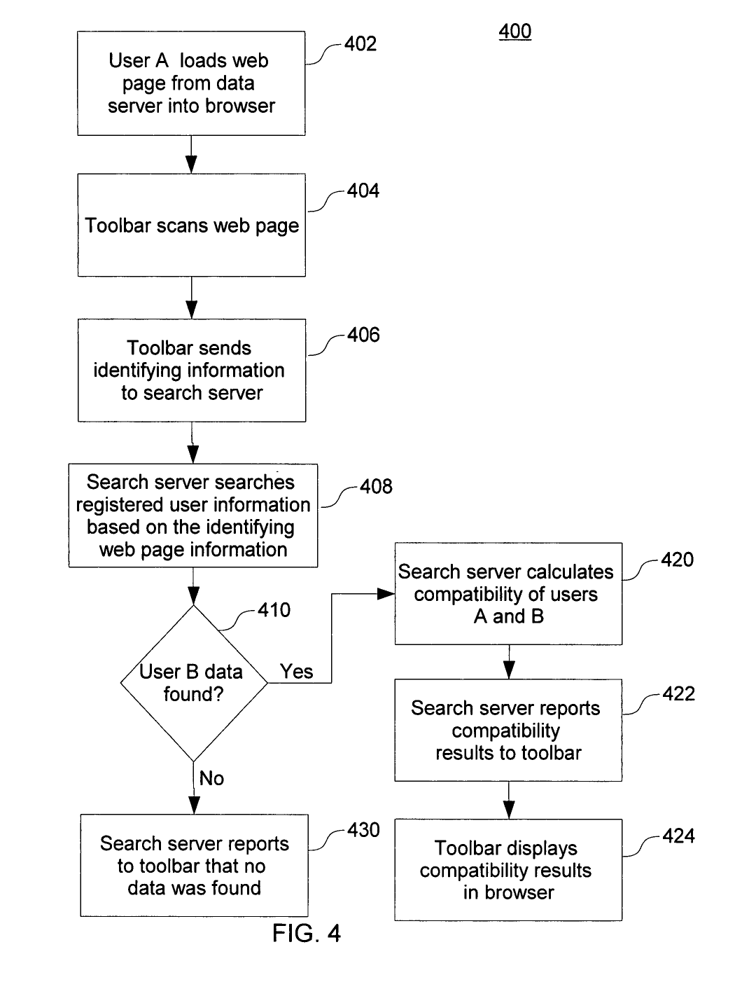

FIG. 4 depicts a block/flow diagram showing a method 400 for determining compatibility of users in accordance with an embodiment of the present principles. Once both User A and User B have registered with the search service in blocks 310, FIG. 3 and 320, FIG. 3, User A has installed the toolbar 204, FIG. 2, as in block 312, FIG. 3, and User B has entered identifying information as in block 322, FIG. 3, User A navigates to a web page, and the web page is loaded into the browser of User A in block 402. The toolbar 204, FIG. 2 then scans the web page in block 404 for user identifying information.

After finding user identifying information in the web page or URL in block 404, the toolbar sends the identifying information to the search server 208, FIG. 2 in block 406. In one useful embodiment, the toolbar may also send the search server 208, FIG. 2 information identifying the user of the toolbar 204, FIG. 2 so that the search server need not keep track of every user logged into the search service. In block 408, the search server 208, FIG. 2 then searches the stored information relating to registered users and groups using the identifying web information. In one useful embodiment, the search server may search a database having relevant identifying information for registered users. The search server 208, FIG. 2 may advantageously search the database using the identifying information sent from the toolbar in block 406.

The search server then determines, in block 410, whether any registered users were found in the database. Should no registered users be found in the database correlating to the identifying information searched, the search server 208, FIG. 2 then reports back to the toolbar 204, FIG. 2 that no match was found, and the process terminates in block 430.

Alternatively, should the search server 208, FIG. 2 find a registered user correlating to the identifying information sent from the toolbar 204, FIG. 2 in block 406, the server then calculates the compatibility of User A and the found users (User B). According to the present principles, the criteria for determining compatibility between users can be of any type. In one useful embodiment, the criteria for determining compatibility will depend on the type of compatibility matching service offered. For example, in an online employment matching service, the criteria for determining compatibility may include comparing model elements such as length and types of past work experience, willingness to travel, salary, business philosophy, or the like. Alternatively, in an online dating service, the model elements compared may include factors such as personality, goals, gender, location, religious preference, age, income, or the like.

After determining the compatibility between User A and User B in block 420, the search server 208, FIG. 2, in block 422, then reports the results of compatibility calculations back to the toolbar 204, FIG. 2. These results may be in the form of a compatibility report.

The toolbar 204, FIG. 2 then displays the compatibility report in the user's browser 202, FIG. 2 in block 424, after which the process 400 terminates. In one particularly useful embodiment, the toolbar 204 may modify the content of the web page displayed in the browser 202, FIG. 2 to display the compatibility report received from the search server 208, FIG. 2. Artisans skilled in Internet communications technology will recognize that a web page may be modified during display by a browser, and associated toolbars, and the like, in many ways. In one useful embodiment, the toolbar 204, FIG. 2 may display a result element by accessing the displayed web page's Document Object Model (DOM) to insert display elements showing the compatibility report. For example, the result element may be a semi-transparent graphic element or image may be overlaid on the displayed web page indicating the compatibility report between User A and User B.

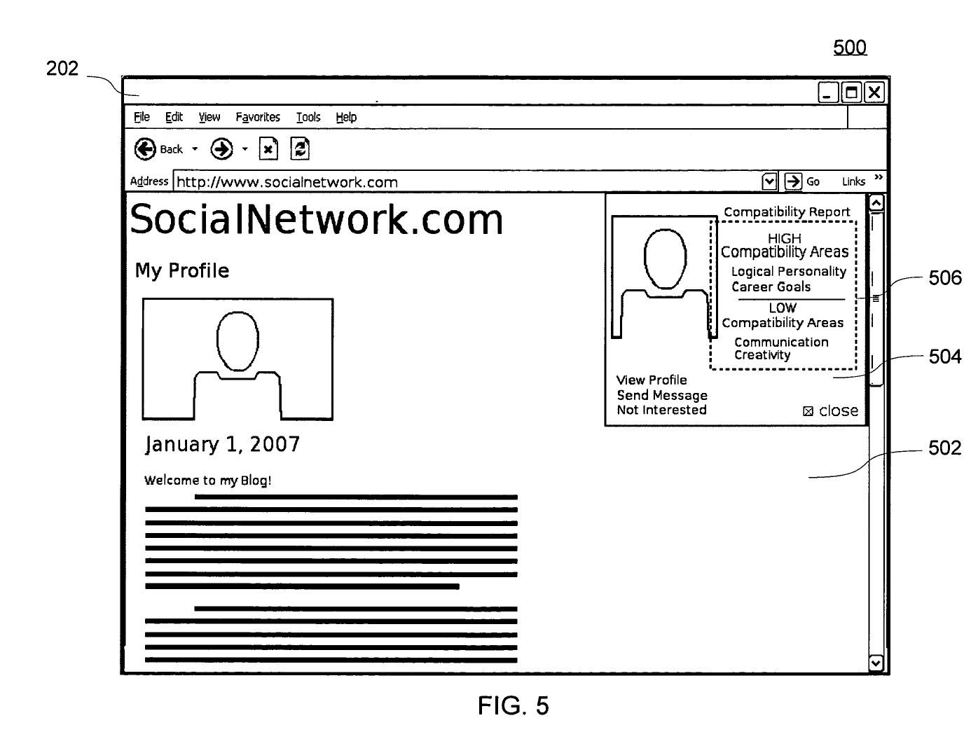

FIG. 5 depicts a useful embodiment 500 of a non-visual browser component displaying a result element 504. In this embodiment, a browser 202 shows a result element 504 in the content pane 502 of the browser 202. The result element 504 may have an area for displaying any compatibility reports 506, as they are received. Where a non-visual browser component captures data and displays a compatibility report, the browser component may show the display element in the browser 202 overlaying the content pane 502. In particularly useful embodiments, the overlaid display element may advantageously have an element which enables a user to close the display element. This feature may be particularly useful when the display element 504 obscures the underlying content of the content pane 502.

Alternatively, the display element 504 may be inserted into the displayed web page itself. In one useful embodiment, the content of the display element 504 may be added into the HTML of the displayed webpage. While this may modify the layout of the web page content, the display element will not obscure any web page content.

The result element 504 may have anchor or link elements permitting User A to click on the element to find out more about the discovered search service user. Thus, User A's clicking on the link may open up a new web page from the search service showing User B's profile. Additionally, the result element may include additional identifying information for user B, such as a photograph, location, search service user name, or the like. The identifying elements shown may be varied based on the type of browser user and web page owner, author, or user registered with the search service. For example, where a company seeking job candidates is registered as a web page owner, the company's logo may be shown, and a link to the company's resume submission instructions may be provided. Where the search service is a social networking or online dating service, the web page user's photo, location and user name may be shown, with a link to the user's profile provided to the browser user.

The result element 504 may be further customized based on the results of the compatibility matching. For example, the compatibility report may show particular model elements, areas, or categories, where User A and User B have a low compatibility, and may also list particular areas where the users have high compatibility. Skilled artisans will recognize that showing the result element 504, and any included display elements, may be determined based on any factors related to a compatibility report, the type of search service, user preferences, or any other related factor without deviating from the teachings of the present principles.

Additionally, in browsers supporting multiple open pages, via tabs or multiple windows, the toolbar may track and simultaneously display compatibility reports from users in different pages, or may show only the users for the active tab or window, changing the displayed compatibility report as different tabs or windows are activated, or brought into focus.

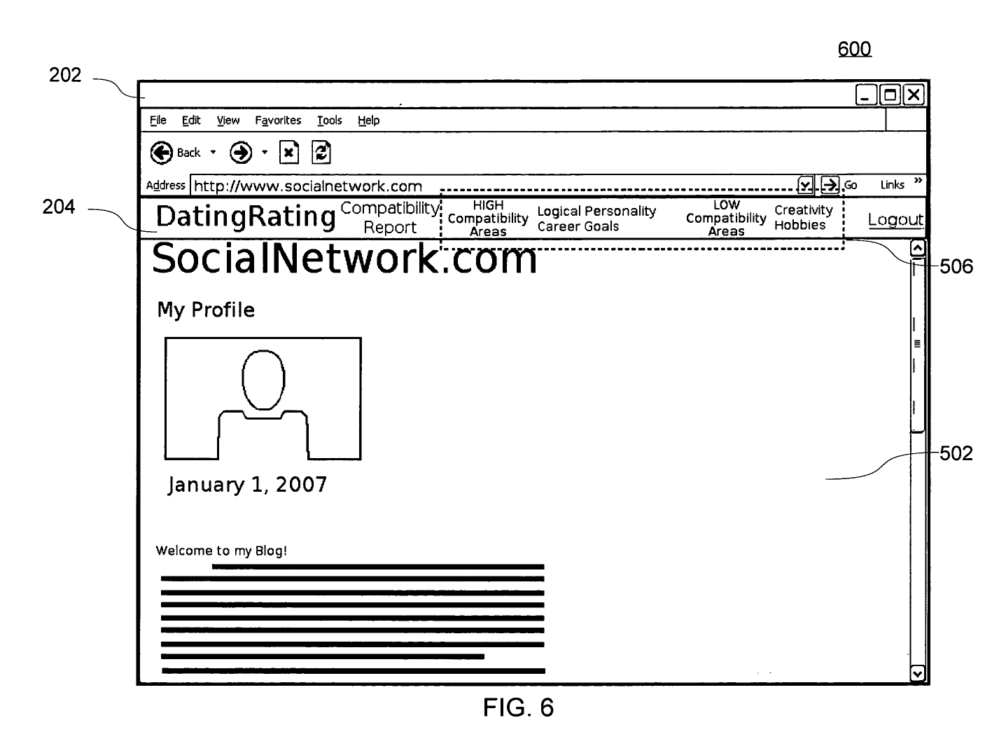

In another useful embodiment, the compatibility report may be shown in a preexisting visual element. FIG. 6 depicts a toolbar 204 that is visually displayed 600 in a web browser 202. Where a toolbar 204 is part of the visual display of the web browser, 202, the toolbar may have a region capable of displaying the compatibility report 506 of one or more users identified with the web page a user is viewing. As discussed above, with reference to FIG. 5, the toolbar may also have anchor, link, or other visual elements displayed to the browser user that are shown in the toolbar 204.

Visual toolbars are known to the art for being embedded in browsers. These toolbars are commonly displayed at the top of the browser window, underneath the standard browser navigational elements. Generally, the toolbars are integrated into the browser such that the toolbar does not overlay or obscure web page content. While the toolbar 204 is shown at the top of the browser's 204 content pane 502 in FIG. 6, the toolbar 204 may be optionally positioned anywhere within the browser.

FIG. 7 shows a browser 202 displaying webpage 502 with a widget 702 in accordance with an embodiment of the present principles. In such an embodiment, the browser may load and display a web page 502 having a widget 702 embedded therein. As discussed above, a widget 702 may be a pre-built section of code that performs a specific function. In many cases the widget 702 is a visual or graphical element displayed on a web page. When used as part of a web page, a widget 702 generally comprises HTML that forms or calls a specific function. According to the present principles, a widget 702 may be used to gather information about a visiting user, and may then present a compatibility report based on the compatibility between the web page owner and the visiting user.

More specifically, as shown in the illustrated useful embodiment, the widget 702 may have an entry field 704 which permits a visiting user to enter user identifying information for generating a compatibility report. This identifying information may include, but is not limited to, a username or email address which the user registered with the search service.

Additionally, the widget 702 also includes functionality for sending the entered visiting user identifying information to the search server where a compatibility report is generated. Likewise, the widget 702 may receive any generated compatibility report from the search server, and display the received compatibility report in the widget 702 display area.

In addition to displaying a compatibility report, the widget 702 may also show a “microprofile” 706 of the web page owner. The microprofile 706 display may include information describing the owner of the web page so that a visiting user may decide if they wish to generate and view a compatibility report.

Having described preferred embodiments of a system and method for identifying the compatibility of users from identifying information gathered from web pages (which are intended to be illustrative and not limiting), it is noted that modifications and variations can be made by persons skilled in the art in light of the above teachings. It is therefore to be understood that changes may be made in the particular embodiments disclosed which are within the scope and spirit of the presented principles as outlined by the appended claims. Having thus described aspects of the present principles, with the details and particularity required by the patent laws, what is claimed and desired protected by Letters Patent is set forth in the appended claims.

What is claimed is:

1. A method for determining and displaying compatibility of a first web page user and an item registered with a search service, the method comprising the steps of:
loading at least one web page into a web browser of a first user, the web browser having a browser component installed for acquiring and displaying a compatibility report;
detecting, by the browser component, identifying information for an item within the web page loaded by the first user;
determining the identity of the item from the detected identifying information;
determining a compatibility between the first user and the item by comparing elements of a model of the first user and a model of the item, the models stored on a server of the search service; and
displaying results to the first user.

2. The method of claim 1, further comprising the steps of:
listing available user identifying information for the item with the search service, the search service storing the identifying information;
generating a user model for each of the first user and a model for the item based on information acquired from the first user and about the item, wherein the models are referenced by the stored identifying information; and
generating a compatibility report based on the compatibility between the first user and the item.

3. The method of claim 1, wherein:
determining the identity of the item comprises the steps of:
sending, by the browser component, the detected identifying information to the server; and
searching the stored identifying information for a match with the stored identifying information.

4. The method of claim 3, wherein the item is a second user.

5. The method of claim 3, wherein the browser component is a visible toolbar, and the compatibility report is displayed in the toolbar.

6. The method of claim 5, further comprising the step of the first user logging into the toolbar to activate the toolbar, the toolbar acquiring and displaying the compatibility report when active.

7. A method for providing a service to determine the compatibility of a first user and a second user, the method comprising:
providing a component to a first user for gathering identifying information regarding a second user;
determining the identity of a second user by comparing identifying information with stored identifying information, the identifying information received from the component;
determining a compatibility between the first user and the second user by comparing elements of a model of the first user and a model of the second user;
generating a compatibility report based on the compatibility between the first user and second user; and
delivering the compatibility report to the component for display.

8. The method of claim 8, further comprising the method steps of
receiving registration information from the first and second user;
receiving a listing of user identifying information for the second user and storing the identifying information; and
generating a user model for each of the first user and a model for the item based on registration information received from the first user and the second user, wherein the models are referenced by the stored identifying information.

9. The method of claim 8, wherein the determining the identity of the second user comprises the step of searching the stored identifying information for a match with the received identifying information.

10. The method of claim 8, wherein the component is a toolbar installed in a browser of the first user, and the toolbar is configured to detect identifying information on web pages loaded by the browser of the first user.

11. The method of claim 8, wherein the component is a widget embedded in a web page by the first user, the widget configured to gather identifying information from a second user browsing the web page.

12. The method of claim 11, wherein the step of providing a component is automatically generating a widget for use by the first user, the widget generated based on the identifying information of the first user.

13. A computer program product comprising a computer readable medium including a computer readable program, wherein the computer readable program, when executed on a computer, causes the computer to perform the steps of claim 8.

14. A system for determining and displaying the compatibility of a first user and at least one web page user, the system comprising:
a component provided to a first user, wherein, upon installation, the component is communicatively connected over a communications network to a search server, and wherein the component is configured to collect identifying information regarding a second user, and send the collected identifying information to the search server; and
a search server configured to receive identifying information from the component and, based on the identifying information, search stored identifying information to determine the identity of the second user, and further configured to determine the compatibility between the first user and the second user to generate compatibility reports and transmit the compatibility reports to the component;
wherein the component is further configured to receive the compatibility reports and display the compatibility reports to the first user.

15. The system of claim 14, wherein the search server is further configured to collect information from each of the first and second users, and to generate a model of the first user and the second user, and wherein the calculation of the compatibility is performed by comparing aspects of the first and second user models.

16. The system of claim 15, wherein the component is a toolbar installed in a web browser, the toolbar configured to monitor web pages browsed by the first user for identifying information.

17. The system of claim 15, wherein the toolbar is a widget configured to be embedded in a web page of the first user, and configured to receive identifying information from the second user.

18. The system of claim 15, wherein the toolbar is configured to customize a monitored web page by showing the compatibility report as a result element.

19. The system of claim 15, wherein the identifying information is a web page uniform resource locator (URL).

20. The system of claim 15, wherein the identifying information includes at least one of: hyperlinks embedded in the web page, addresses of electronically deliverable resources embedded in the web page, email addresses embedded in the web page, and user names.
